(19) United States
(12) Patent Application Publication
(10) Pub. No.: US 2026/0094492 A1
(43) Pub. Date: Apr. 2, 2026

(54) SYSTEMS AND METHODS FOR MODULAR CARD GAMES

(71) Applicant: Interblock d.o.o., Menges (SI)

(72) Inventors: Peter KROSELJ, Kamnik (SI); Mirko KLANJSCEK, Ljubljana (SI); Urban BERGANT, Kamnik (SI); Andrej TOMELJAK, Preserje pri Radomljah (SI); Kristjan AZMAN, Domžale (SI); Matic HRIBAR, Ravne pri Šmartnem (SI); Bojan ROTAR, Ljubljana (SI)

(21) Appl. No.: 19/095,765

(22) Filed: Mar. 31, 2025

Related U.S. Application Data
(60) Provisional application No. 63/702,453, filed on Oct. 2, 2024.

(51) Int. Cl. G07F 17/32

(52) U.S. Cl. CPC G07F 17/3216; G07F 17/3293

(57) ABSTRACT

A card randomization system comprises a drum with a plurality of slots to store cards. Each slot holds one type of card and comprises a locking arm to restrain the card in the slot. A randomization process determines a card to be extracted from the drum. The drum aligns a slot associated with the card with an extraction mechanism. The extraction mechanism comprises a first belt on a first side of the card and at least one of a second belt or a plurality of rollers on a second side of the card. A locking arm actuator unlocks the locking arm and the extraction mechanism extends at least partially into the slot to extract the card. A camera takes an image of the card to determine an identity of the card, and the card is transported to an output system, based on the determined identity of the card.

### RELATED APPLICATIONS

This application claims the benefit of U.S. Patent Application No. 63/702,453, filed Oct. 2, 2024.

### TECHNICAL FIELD

The present disclosure relates generally to the field of gaming, primarily to modular card game systems.

### BACKGROUND INFORMATION

Casinos offer numerous games to provide exciting gaming options for users of all levels of interest and skill. In particular, many different types of physical card games are offered for play to attract many types of users. Card games are often implemented with a classic 52-card deck, and numerous games are played using the same, or small variations on, the classic 52-card deck. Casino games have increasingly turned to digital interfaces and mechanical devices to automate gaming experiences to provide more options. New games have been created using electronic devices, and previously known games have been updated to incorporate partial or full automation using electronic devices. Many users desire gaming environments that incorporate at least some physical gaming elements to evoke a more engaging gameplay experience than a solely electronic or automated alternative.

New variations of games are constantly being offered for play that may be preferable for some users. A single type of game may be offered with multiple levels of electronic and automated integration. For example, a card game may be fully manual, using a human dealer to shuffle and deal the cards and manage the game. The same card game may incorporate an automated shuffling device, an automated presentation device, or other types of automated devices in a modular format to streamline the game and provide users with a more preferable gaming experience.

### SUMMARY

An embodiment is directed to a system for operation of a modular card randomization system, comprising storing a plurality of cards in a drum associated with the card randomization system, wherein the drum comprises a plurality of slots configured to store cards, and wherein each slot of the plurality of slots holds one type of card of the plurality of cards. A randomization process may determine a first card to be extracted from the drum. The drum may be rotated to align a first slot associated with the first card with an extraction mechanism, wherein the first slot comprises a first locking arm configured to restrain the first card in the first slot, and wherein the extraction mechanism comprises a first belt on a first side of the first card and at least one of a second belt or a plurality of rollers on a second side of the first card. The first locking arm may be unlocked via a locking arm actuator. The extraction mechanism may extend partially into the first slot, and the extraction mechanism may extract the first card from the first slot. The system may determine, based on an image of the first card taken by a camera, an identity of the first card. Based on determining that an assigned identity of the first card matches the determined identity of the first card, and via the first belt, the first card may be transported to an output mechanism of the card randomization system.

These and other features will be more clearly understood from the following detailed description taken in conjunction with the accompanying drawings and claims. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a close-up view of a first portion of a mechanical card shuffling device, in accordance with an embodiment.

FIG. 2 is a close-up view of a second portion of a mechanical card shuffling device, in accordance with an embodiment.

FIG. 3 is a side view of a mechanical card shuffling device, in accordance with an embodiment.

FIG. 4 is a close-up view of a third portion of a mechanical shuffling device, in accordance with an embodiment.

FIG. 5 is an example view of a card identification system, in accordance with an embodiment.

FIG. 6 is a close-up view of a fourth portion of a mechanical shuffling device, in accordance with an embodiment.

FIG. 7 is a side view of a portion of a mechanical shuffling device, in accordance with an embodiment.

FIG. 8 is a perspective view of a game table, in accordance with an embodiment.

FIG. 9 is a close-up view of a fifth portion of a mechanical shuffling device, in accordance with an embodiment.

FIG. 10 is a flow chart of an example method of operating a modular card game, in accordance with an embodiment.

FIG. 11 is an example of a computing system, in accordance with an embodiment.

### DETAILED DESCRIPTION OF EMBODIMENTS

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

Disclosed herein are systems and methods for presenting a modular card gaming systems for users to use in playing card games. The modular card gaming system comprises a plurality of modular elements that can assist with randomization and shuffling, dealing, presentation, clean-up, and playing of games associated with one or more decks of playing cards. The playing cards may be a classic 52-card deck of playing cards. The system may allow for automation of certain portions of the card-gaming playing environment. For example, the randomization—i.e., shuffling—of cards may be automated using a randomization process, for example a randomization algorithm, and the cards may be selected and physically presented in an order determined by the randomization process. In an embodiment, the randomization process may determine one card to be selected, and the card may be selected and physically presented for gameplay. As the system selects and presents the first card, the randomization process may determine another card to be presented for gameplay. Thus, individual cards may be randomly determined in real-time, as selection and presentation of other cards are presented for gameplay. The cards may be held in a holding device, for example a drum, and the cards may be extracted from slots in the drum in the order determined by the randomization system. The presentation of the cards via a presenter may be automated or the cards may be manually presented by a dealer using a shoe. The clean-up of the cards may be automated to return the cards to the drum automatically, or a dealer may place the cards in a stacker to be returned to the drum. The cards may be continuously shuffled—e.g., the cards may be fully reset in the slots of the drum after each game—or the cards may be classically shuffled—e.g., cards used in one game may remain out of the possible card pool for a future game until a trigger is met to reshuffle all used cards. The trigger may be a cut card. The cards may be monitored to ensure that each card presented for users matches an identity determined by the randomization system. The monitoring may comprise an image detection system to view each card and determine that the card matches the type of card that is supposed to be presented. The image detection system may comprise one or more cameras associated with an output system to ensure presentation of correct cards, as determined by the randomization process. The image detection system may comprise one or more cameras associated with an input system of the cards to ensure used cards are returned to the correct slots in the drum. The drum may comprise components to hold each card in a designated area and to present and return the cards to a correct designated area after presentation, for example slots.

The cards may be output from the drum to an output stacker. The cards may be output to the output stacker in the order determined by the randomization process. The output stacker may be large enough to hold a plurality of cards, for example the output stacker may be large enough to hold up to 52 cards, or the like. A manual dealer may manually remove cards from the stacker to present the cards for gameplay. The output stacker may pass the cards along to a card shoe, and the dealer may draw the cards from the card shoe to present the cards for gameplay. The output stacker and/or the card shoe may have locking mechanisms to prevent dealers from drawing cards before an allowed trigger occurs. Cards used in a game may be discarded and returned to corresponding slots in the drum. The cards may be placed in an input stacker configured to transport the cards to an input mechanism for returning the cards to appropriate slots in the drum. The output stacker and the input stacker may be different stackers. The output stacker and the input stacker may be a same stacker used at different times. The output stacker and/or the input stacker may be hidden from a tabletop of a gaming area by default, and one or both of the stackers may remain hidden and pass cards along to other components of the system while hidden. In an embodiment, a dealer may determine a need to interact with a stacker, and the dealer may activate a motor to raise the stacker from the hidden position to a visible position. The stacker may remain visible for a period of time, for a set number of games, or for a period of time the dealer interacts with the stacker.

Though the cards may be sent to an output stacker and manually dealt by a dealer, the cards may also be sent from the output stacker to an automated presenter. The presenter may present the cards in the randomized order during gameplay without requiring a manual dealer to do so, and the presenter may cycle used cards automatically back into the input stacker and into the input system. Thus, the presenter removes the requirement for a manual dealer to draw, deal, and facilitate gameplay of a game using the cards. Dealers may still be present at a gaming table when using an automated presenter. A game area may comprise any combination of modular elements of the system, comprising the card randomization system, one or more stackers, a card shoe, and a presenter. Game areas, for example gaming tables, may be convertible to support use of any one or more of the modular gaming elements described herein.

The slots may each hold one card type. For example, each one of the 52 slots may hold one type of card, though each slot may hold multiple copies of the same type of card. For example, the system may be loaded with eight or more decks of cards, so each slot may hold eight or more cards of a type. The drum may comprise a circular drum with a plurality of slots, and each one of the slots may be able to hold the plurality of cards. Each holding area may hold a plurality of copies of a same type of card. The drum may comprise more than 52 slots, even when the game is played with a standard 52 card deck. Cards beyond the 52 slots used to hold the typical 52 cards in a standard card deck may be left empty or may be filled with additional card types. For example, the additional slots may hold a cut card, a wild card, a bonus card, a joker card, or the additional slots may be used as repositories for unusual cards. For example, the additional slots may hold unrecognizable cards, damaged cards, error cards, or the like. A locking mechanism may lock each slot to prevent cards in the slot from being removed unintentionally, and the locking mechanism of a particular slot may be unlocked to allow cards in the particular slot to be removed. An output transport mechanism may transport a card from a holding area to a stacker, and the stacker may transfer cards to a presentation system. Cards used during a game may be transported back to the drum via an input transportation mechanism, in which the cards are removed from the presentation area and returned to a corresponding slot. The cards may be imaged via one or more cameras to determine identities of the cards being returned to ensure the cards are returned to the correct slots.

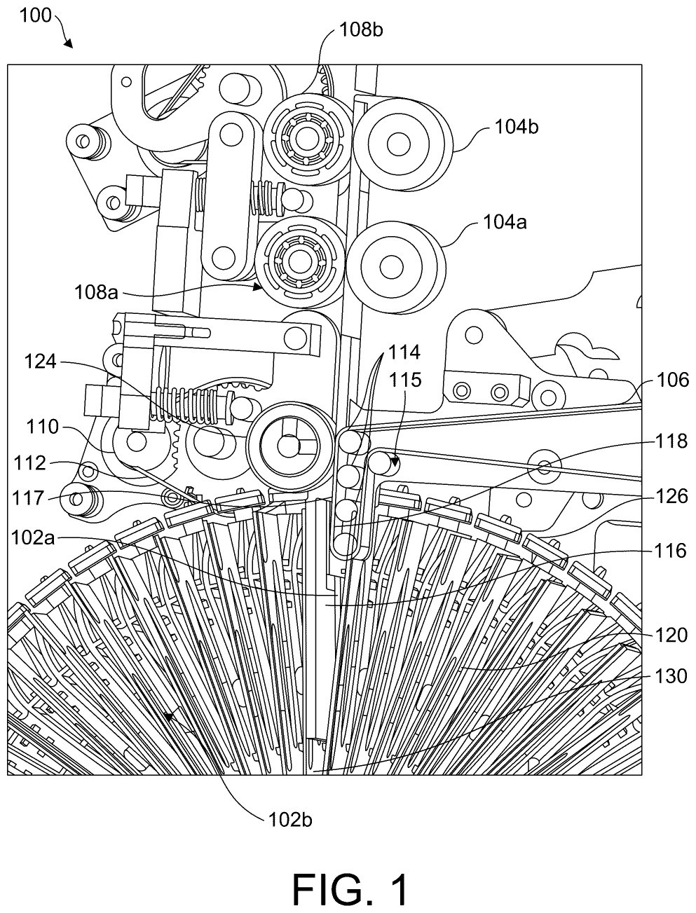

FIG. 1 shows an example modular card game system. In particular, FIG. 1 shows a close-up of a portion of the system comprising a partial view 100 of a drum 130 and several slots 102a, 102b in the drum 130, along with an extraction mechanism configured to extract cards from slots in the drum 130. A slot 102b is shown in a default locked state. The slots of the drum 130 are typically maintained in a locked state, in which contents within the slot are restrained from falling out of or being extracted from the slots. Another one of the slots 102a is shown in a configuration for extracting a card by an extraction mechanism. A locking arm 120 has a cover piece 126 which is positioned to cover an opening of a slot, and each slot has its own locking arm 120 and cover piece. At one or more positions in the system, locking arms of slots may be actuated to move a locking arm away from a slot and reveal the contents of the slot for extraction. For example, locking arm 120 is shown in a default, locked position and covers a top of a slot. Though not listed, slot 102a is in a configuration with its associated locking arm in an unlocked position to reveal the inner contents of the slot 102a.

With the slot 102a in the unlocked state, an extraction mechanism may extract a card 116 nested within the slot 102a. The card 116 may be the only card in the slot 102a, or the card 116 may be one of a plurality of cards within the slot 102a. In a configuration in which multiple cards are nested within the slot 102a, each card in the slot 102a are of a same type. For example, each card in the slot 102a may be a two of spades card type. The slot 102a may be associated, in a related computing process, with the two of spades card type. Therefore, upon determining that a two of spades should be dealt to a player of a game using the card randomization system described herein, the drum 130 may be rotated to position the slot 102a with the extraction mechanism so that the two of spades within the slot 102a may be extracted and sent to a play area.

The extraction mechanism comprises an extendible portion 118 that may be extended partially inside an unlocked slot 102a to interact with a card 116 nested therein. The extended portion may comprise one or more rollers 114 and a belt 106. The belt 106 may be operable in both directions. The outer surface 117 of the belt 106 in the extendible portion 118 may come into contact with a card 116 in the slot 102a. For example, the extendible portion 118 may be extended into the slot 102a, and the drum 130 may be slightly rotated to push a side of the card 116 into contact with the outer surface 117 of the belt 106. Friction between the outer surface 117 and the card 116 allows the belt to rotate outward away from the drum 130 and extract the card 116 from the slot 102a. Rollers 114, 115, may be actuated by a motor to drive the belt and cause the card 116 to lift out from the slot 102a. The card 116 may come into contact with a friction roller 124, and the belt 106 and friction roller 124 may move in opposing directions to drive the card 116 upward along the extraction mechanism path. In one embodiment, the friction roller 124 may spin at a speed that causes a surface of the friction roller 124 to travel at a different speed than a speed of the belt 106. The differential speed between the friction roller 124 and the belt 106 causes a sheer force on the card 116. It is possible that multiple cards in the card slot 102a may stick together and be extracted in one stack, which is undesirable and can cause errors or faults in the card randomization game system. Thus, the sheer force created by the differential speed of the friction roller 124 and the belt 106 can un-stick the stack of cards extracted from the slot 102a. A first card 116 of the stack can be propelled further along the extraction mechanism path, and the remaining card(s) can be dropped back into the slot 102a. The friction roller 124 may be driven by a motor 110, and the motor 110 and the friction roller 124 may be coupled via a belt 112. The card 116 may be moved along the path of the belt 106 and away from the slot 102a, and the tip of the extraction mechanism 117 may be removed from the partial insertion into the slot 102a.

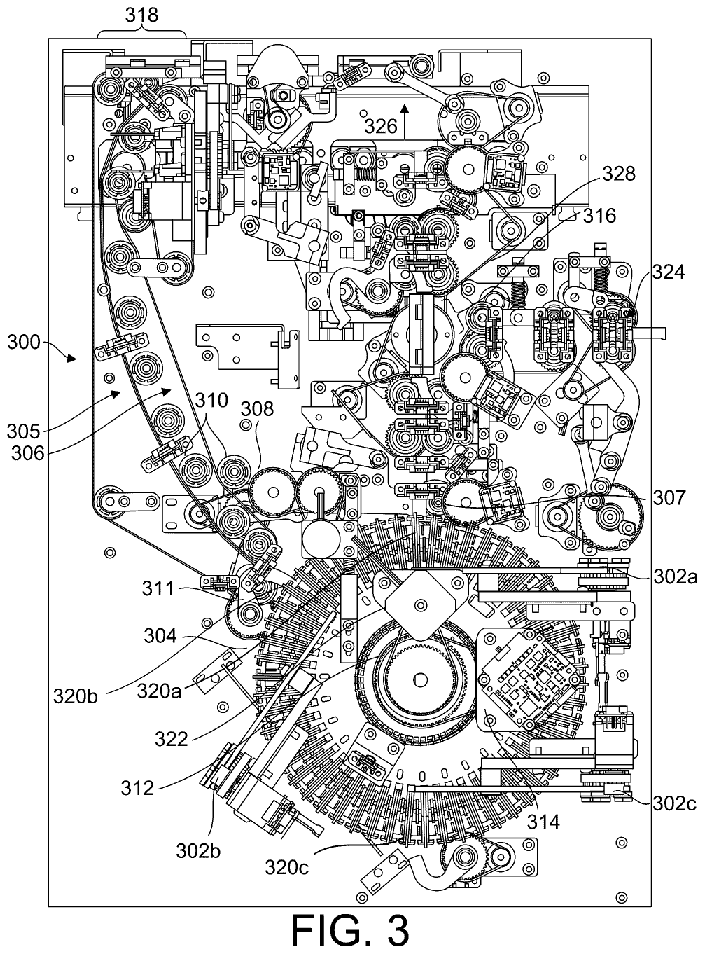

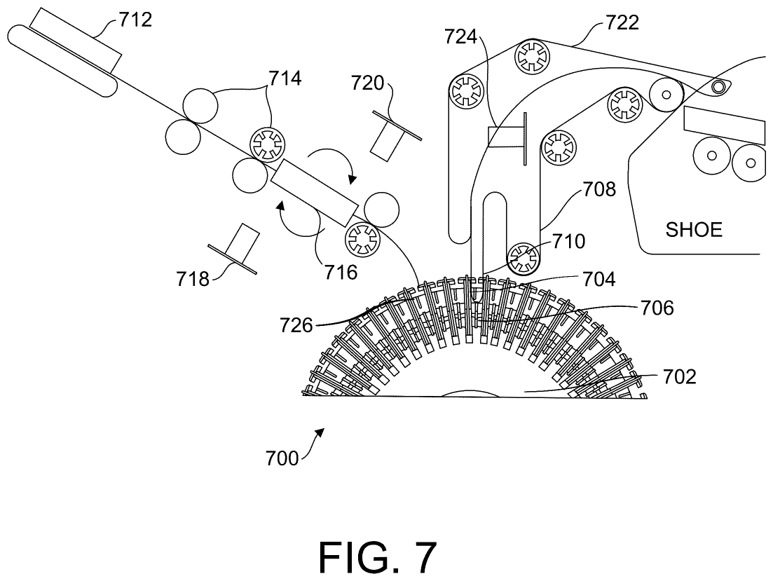

The card 116 may proceed along the extraction mechanism path toward an output of the card randomization system, and the card may pass through additional sets of rollers 104a and 108a. The opposing rollers 104a and 108a contact the card 116 and produce friction on the card 116. The spinning of the rollers 104a and 108a further propel the card 116 along the path toward an output. Additional rollers 104b and 108b may be placed on the output path of the extraction mechanism. Though two sets of opposing rollers 104a and 108a, and 104b and 108b are shown in FIG. 1, there may be less than, or more than, two sets of opposing rollers to propel the card 116 to the output of the system. The quantity of sets of opposing rollers partially depends on the length of the path from extraction to output, though other considerations such as desired speed of the card and wear on the card may determine the quantity of sets of opposing rollers. Though not shown in FIG. 1, any one or more of the rollers 124, 104a, 108a, 104a, or 108b, may be replaced with additional belts, and the card 116 may be transported along the output path using friction from opposing belts. The opposing belt system is described in more detail, for example, in FIGS. 3 and 7.

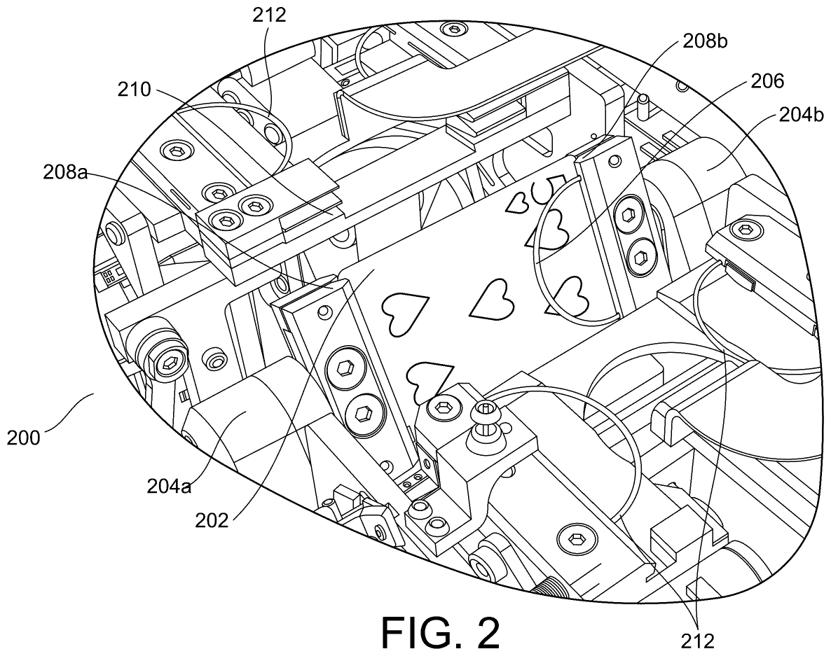

FIG. 2 shows another partial example of the modular card game system described in FIG. 1. In particular, FIG. 2 shows a close-up of a card rotator system 200. Because the face and back of each card presents differential information, it is important to be able to rotate cards to place the cards in a correct orientation for various steps of the system. For example, the card randomization system is ultimately designed to allow for at least partially automated delivery of cards to a playing area for players to participate in a game. Thus, the cards should be presented to the players in a particular orientation to facilitate gameplay. For example, the players may play a game against one or more cards held by a dealer. The players may be required to make wagers without knowing some or all information about cards the dealer holds. Therefore, the cards may have to be presented face-down to ensure players are not able to view information on a face of a card when dealt to the dealer. Moreover, the cards may need to be rotated within the card randomization system's internal components to provide for a more efficient storage and selection process. Cameras may be used to take images of a face of a card to determine an identity of the card. The cameras may only be positioned on one side of the card, so the cards may need to be rotatable within the card randomization system to ensure a face of each card is passed through the camera field of view.

FIG. 2 shows a card 202, for example a five of hearts type card 202 in the card rotator 200. The system may comprise rotating supports 204a, 204b, that may support and actuate to rotate card end slots 208a, 208b. The card 202 may be moved, via rollers and/or belts, through a pathway that moves the card 202 into position to enter the card rotation system. The card may exit the pathway at slot 210 and enter the card rotation system, and the card may be moved into position within the card end slots 208a, 208b. The card end slots 208a, 208b may grab each end of the card 202 and hold the card 202 in a static position. The card end slots 208a, 208b may then be rotated by the rotating supports 204a, 204b, to turn the card 202 over to an opposite side. Thus, the card 202 may enter the card rotation system face-down and may exit the card rotation system face-up. To reduce the possibility of the card 202 moving while engaged with the card end slots 208a, 208b, the card end slots may comprise braces 206 to support more than just each end of the card 202 while the card is coupled to the card end slots 208a, 208b. The brace may be a flange, a wire, or a plate that extends over the face or back of the card. Additional braces 212 may be positioned on the pathway adjacent to the card rotation system to assist the card with transitioning from the pathway to the card rotation slot, and vice versa, without becoming creased, wrinkled, damaged, or otherwise moved into an undesirable position. The rotated card may be passed through the card rotation system into an output pathway on another side of the card rotation system from the input pathway. The output pathway may pass the rotated card to another component of the card randomization system.

The card rotation system may be duplicated in multiple areas of the card randomization system described in embodiments herein. For example, the card randomization system may comprise a card rotation system along an output path from the drum 130 to an output of the system. The card rotation system may be placed along an input path between an input of the card randomization system and the drum 130. The card rotation system may be incorporated as at least a portion of a presenter of the system. The presenter may allow for automated presentation of the cards to facilitate gameplay without requiring cards to be physically removed from the card randomization system and dealt to individual players. The presenter may comprise a plurality of presentation spaces, and some presentation spaces may preferably require a card to be shown face-down while other presentation spaces may preferably require a card to be shown face-up. The transition from face-down to face-up, and vice versa, within the presenter may be carried out by the card rotation system described herein.

FIG. 3 shows an example of the card game randomization system described herein. The system comprises a drum 304, similar to drum 130 described in FIG. 1. The system describes a series of belts and rollers along multiple pathways to facilitate movement of cards into and out of the drum 304. In particular, the drum 304 is shown with three locking arm actuators 302a, 302b, and 302c, that may be used to actuate locking arms on slots of the drum 304. For example, the locking arm actuator 302a may be used to unlock the locking arm associated with slot 320. As the drum 304 is rotated, different slots may be moved into the position shown as occupied by slot 320, and the corresponding slot may be unlocked by locking arm actuator 302a.

Locking arm actuator 302a is associated with a portion of the card randomization system for extracting cards from the drum 304 to be used in a game. For example, a randomization process may determine an order of cards to be presented on a play area to facilitate gameplay. The system may determine a first card of the order of cards and may remove, via extraction mechanism 307, a copy of the first card from a corresponding slot in the drum 304. The drum 304 may be rotated to position a slot associated with the first card, for example slot 320a, toward the extraction mechanism 307. The drum 304 may be rotated using one or more motors. For example, a gross motion motor 314 may drive a belt 312 coupled to a gear of the drum 304 to rotate the drum. The gross motion motor 314 may have offer more power but less precision than a fine motor. The gross motion motor 314 may drive the drum 304 substantially toward a desired position, and a fine motor 322 may drive the drum 304, with greater precision, to a final endpoint of the desired position of the drum 304. The locking arm actuator 302a may cause a locking arm, that typically covers an opening of a slot in a default position, to be removed from covering the opening of the slot 320a. A tip of the extraction mechanism 307 may be moved partially into the slot 320a, and a belt of the tip of the extraction mechanism may be driven to pull a card out of the slot 320. The card may be passed along the belt of the extraction mechanism 307 toward an output of the card randomization system. The card may be passed along the output pathway 326 via one or more belts and/or one or more rollers. The card may pass through a rotator 316, and the rotator may optionally rotate the card. Rotating the card may align a face of the card in a desired direction, or rotating the card may align the card with a belt or roller associated with the pathway. In some embodiments, the extraction mechanism and at least part of the output pathway may also be used as an input pathway and insertion mechanism. That is, spent cards may be returned to the card randomization system, passed along the output pathway, and inserted back into a correct slot of the drum 304 via the same output pathway and extraction mechanism 307 shown. The extraction mechanism 307 and output pathway may be oriented to remove cards from slots substantially vertically. The cards may be driven along on belts 324 and/or 328 to an output of the card randomization system.

Locking arm actuator 302b is associated with a portion of the card randomization system for inserting cards back into a correct slot 320b of the drum 304, for example for re-inserting used card that were used in a game. For example, a card may be used in a game, and an automated system or a manual system may return the used card to a stacker or other input mechanism to return the used card to the drum 304. The card may optionally be moved into a rotator 318 upon initial insertion into the input pathway of the system. The card may require imaging to determine an identity of the card to return the card to a correct slot 320b in the drum 304, and the card may need to be oriented in a particular direction to facilitate effective imaging. The cards may be returned to the input pathway either face-up or face-down, so it is desirable to have a rotator 318 to align the returning cards in a same orientation. The card may pass through the input pathway in between belts 305 and 306. The belts may oppose one another and a first face of belt 305 may touch an opposing face of belt 306 along the input pathway. The belts may be driven by rollers, for example rollers 310. The returning card may be sandwiched between the belts 305 and 306 to facilitate movement of the card through the input pathway. A motor system 308 may drive the belts 305 and 306. The card may pass through an imaging system, for example one or more cameras. The imaging system may take an image of the card, and a system may determine, based on the image, an identity of the card. For example, the imaging system may determine the card is a six of clubs. The card may be returned to a position adjacent to the drum 304. The drum 304 may rotate to present a slot 320b associated with the card to a position adjacent to the card return position. For example, the drum 304 may be rotated to present a slot 320b associated with the six of clubs to the card return position. The drum 304 may be rotated using one or more of the gross motion motor 314 or the fine motor 322. The locking arm actuator 302a may cause a locking arm, that typically covers an opening of a slot in a default position, to be removed from covering the opening of the slot 320b. The belts 305 and 306 may be driven to move the card partially toward the slot 320b. A pusher arm 311 may actuate to push the presented card the rest of the way into the slot 320b. The pusher arm 311 may retract, and the locking arm actuator 302b may release the locking arm to lock the slot 320b with the card inside.

Locking arm actuator 302c is associated with a portion of the card randomization system for removing cards from the system. For example, a slot 320c may be associated as a repository for unusable cards. Cards may become damaged, marked, unrecognizable, or otherwise unusable over the course of gameplay. For example, the system or a user may bend a card, tear a card, or a user may improperly mark a card with a substance. The card may become altered to the point where the imaging system no longer recognizes an identity of the card. The card may be associated with an error. For example, the system may load eight decks of cards into the drum 304, so the system assumes there are eight copies of each type of card in the system.

However, the imaging system may image a card and assign a card type to a card that the system believes is already represented by eight other copies of the assigned card type. The system may determine that the imaged card is an error. Based on any one or more of the above circumstances, the system may determine to remove a card from the system, and the card may be placed in a slot 320c associated with card removal. The drum 304 may be rotated to associate slot 320c with locking arm actuator 302c, and the locking arm actuator 302c may actuate to cause a locking arm of slot 320c to unlock. The slot 320c may point substantially vertically downward, and gravity may cause all cards in slot 302c to fall out. Below the drum 304 (though not shown) may be a basin for collecting cards dumped out of slots in position 320c. In one embodiment, the system may require partial or complete emptying to facilitate maintenance, quality control, or the like.

Emptying many, or all, of the slots manually may be cumbersome. To improve the process, the drum 304 may cycle through such that all slots that should be emptied pass through the position occupied by slot 320c, and each such slot may be emptied in turn. Though a particular slot may be associated with a particular card type, the slots may be emptied, and the system may randomly assign new card types to some or all of the slots. Doing so may reduce a possibility of cheating because slots are not permanently associated with particular card types.

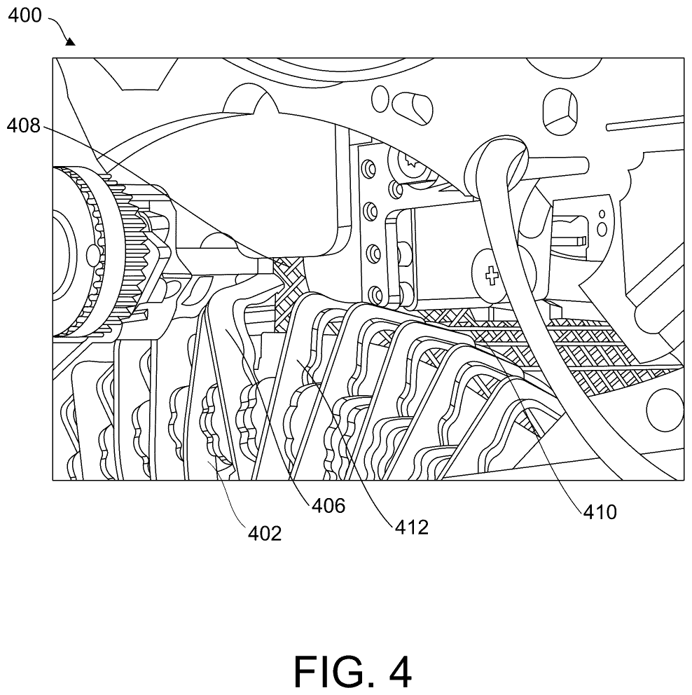

FIG. 4 shows another partial view of the modular card game system described in FIG. 3. In particular, FIG. 4 shows a close-up of a card extraction system 400. A drum 402 is configured with a plurality of slots. In one embodiment, the drum 402 comprises 52 slots to match with 52 card types in a standard deck of playing cards. In other embodiments, the drum 402 comprises more than 52 slots. Slots may be used for the standard 52 playing card types, and additional slots may house other types of cards, for example cut cards, bonus cards, joker cards, wild cards, altered or unrecognizable cards, or the like. The extraction mechanism may extract a card from a particular slot of the drum 402. However, the slots may be covered by a locking arm to prevent access to the slot. To provide access to the slot for the extraction mechanism, the locking arm may be actuated to move the locking arm out of a default, locked position and to provide access to the slot. Locking arm 406 is actively engaged by a locking arm actuator, and the locking arm 406 is moved out of the way of an opening of the corresponding slot. The extraction mechanism may extract a card 408 from the slot made available by removing the locking arm 406 from blocking an opening of the slot. The extraction mechanism may unlock one slot at a time, and the drum 402 may be rotated to provide the extraction mechanism access to different slots. For example, a slot next to the active slot may be locked by locking arm 412, and card 410 may be inaccessible to the extraction mechanism. The system may disengage locking arm 406 to lock the corresponding slot, rotate the drum 402 to present the next slot to the extraction mechanism, and allow for locking arm 412 to be actuated to allow extraction of card 410.

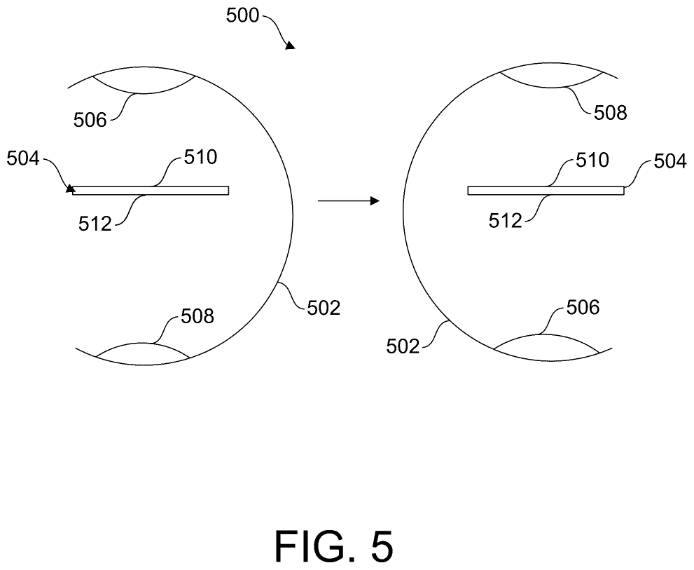

FIG. 5 shows an imaging component 500 of the modular card randomization system described in, for example, FIG. 3. In particular, FIG. 5 shows different configurations of cameras movable about a card in the system. As described previously, cards may be passed through the card randomization system from a drum, to an output, and from an input, back into the drum. At various points along the system it may be advantageous for the system to know an identity of the card passing through. For example, the system may intend to extract a particular card from the drum, and the system may take an image of the card extracted from the drum to confirm that an actual identity of the card matches an assumed identity of the card. Because cards typically show different information on a card face versus a card back, it may be necessary to implement a method for imaging multiple angles of the card. The imaging multiple angles of the card may be accomplished in multiple ways, as presented by different embodiments described here. In FIG. 5, for example, the system may comprise multiple cameras. Additionally, the multiple cameras may optionally rotate about the card to capture pictures from multiple sides of the card.

Card 504 may pass through an imaging component of the card randomization system, comprising a plurality of cameras 506, 508. A first side 510 of the card 504 may be imaged by a first camera 506, and a second side 512 of the card 504 may be imaged by a second camera 508. The system may view one or both of the image of the first side 510 and the image of the second side 512 to determine an identity of the card 504. However, one of the cameras 506, 508 may malfunction. For example, the system may need an image of the first side 510 of the card 504, but the first camera 506 may be inoperable, or the system may need an image of the second side 512 of the card 504, but the second camera 508 may be inoperable. In one embodiment, the system may compensate for such an error by rotating the cameras 506, 508 about the card 504. In a first position, the camera 506 may image a first side 510 of the card 504 while a second camera 508 may image a second side 512 of the card 504. In a second position, the camera 506 may image a second side 512 of the card 504 while the second camera 508 may image the first side 510 of the card 504. In the described embodiment, if either camera 506 or 508 is inoperable, the other camera may still capture suitable images of the card 504 regardless of which side the system requires an image of.

Though not pictured herein, other embodiments may be implemented to ensure suitable image detection for cards in the card randomization system. For example, the cameras may not rotate about the card, but the two cameras may be static. The system may comprise three or more cameras to capture images of multiple sides of the card 504. The system may comprise a single camera that rotates about the card 504. The system may comprise a rotation system for rotating the card within the image capture area. The system may comprise the rotation system for rotating the card, and the system may also comprise one or more cameras rotating about the card.

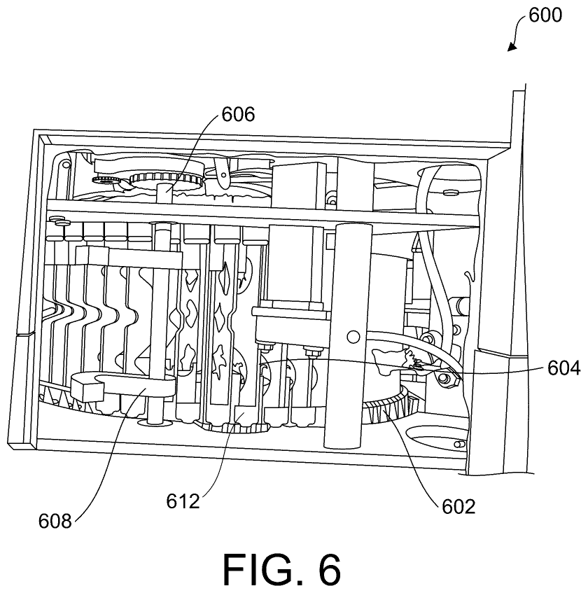

FIG. 6 shows a top-down view 600 of a drum and a pusher element 608. The pusher 608 may be used to push a card into a slot, for example slot 612 may house one or more cards 604 of a particular type, and the cards may be used to facilitate gameplay in a gaming area associated with the card randomization system. The card 604 may be used in the game and returned to the slot 612 via belts and/or rollers as described, for example in FIG. 3. However, the belts and/or rollers may not be able to fully reset the card 604 in the slot 612. Thus, it may be desirable to incorporate an additional element, such as pusher 608, to fully seat the card 604 in the slot 612. The input belts and/or rollers described in FIG. 3 may return the card 604 partially into the slot 612, and the pusher 608 may be actuated to rotate along its axel 606. The pusher 608 may contact an end of the card 604, and the card 604 may be pushed fully into the slot 612.

FIG. 7 shows a side view 700 of a drum, an input mechanism, and an output mechanism. The drum 702 may hold a plurality of cards in a plurality of slots, for example slot 706. The cards may be output, using an output mechanism, to a shoe for use in a play area. Used cards may be returned from the play area to an input mechanism and returned to the cards'respective slots. The system is shown in a state in which a locking arm 704 of the slot 706 is disengaged by a locking arm actuator (not shown), and the extraction mechanism in the process of extracting a card from the slot 706. The card may be extracted from the slot 706 via an extended portion 710 of belt 708. The extended portion 710 may come in contact with the card and pull the card out of the slot 706 via friction. The card may be passed along the belt 708 and reach a portion where a first face of belt 708 is in contact with an opposing face of belt 722. The two belts may sandwich the card and drive the card along the output path toward the shoe and play area. The card may pass through an imaging area, in which camera 724 takes one or more images of the card and the system confirms, based on the one or more images, an identity of the card. The system continues to pass the card along the output path and to the card shoe and play area for gameplay. In one embodiment, the card may be passed along an output path to an output stacker, and the card may be passed from the output stacker to the card shoe.

Cards may be used in gameplay at the game area, and used cards may be returned to the randomization system to be replaced into the cards'respective slots in the drum. The cards may be placed into a used card area, for example an input stacker. The input stacker may be a different stacker than the output stacker, or the input stacker may be a same stacker as the output stacker. The used card may be returned to an input card delivery 712, and the card may be moved through the input path via a belt. The belt may be propelled by one or more of rollers 714, or the card may come in contact with one or more of the rollers 714 directly. The card may enter a rotation area, and the card may be optionally rotated in the rotation area. The card may pass through an imaging area, in which one or more of cameras 718 and 720 take one or more images of the card. The system may confirm, based on the one or more images taken by one or more of cameras 718 and 720, an identity of the used card on the input pathway. The system may determine a particular slot 726 associated with the identity of the card, and the drum 702 may be rotated to present the slot 726 with the card input pathway. As with the extraction mechanism, a locking arm associated with the slot 726 may be actuated to reveal the slot 726, and the used card may be placed into the slot 726. The slot 726 may already host one or more additional copies of the card, or the slot 726 may be empty.

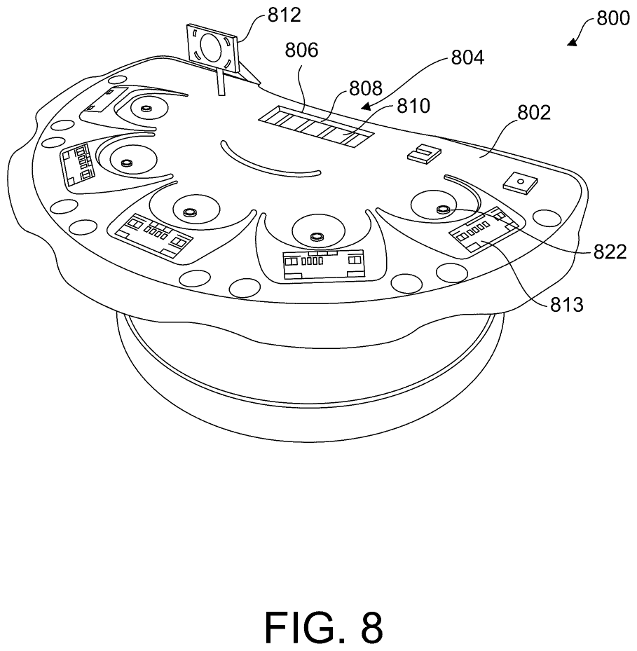

FIG. 8 shows an example gaming table 800 that may be implemented to carry out gameplay using cards provided by the card randomization system described herein. The card randomization system may be implemented inside the gaming table 800, or the card randomization system may be implemented as a separate device from the gaming table 800. The gaming table 800 may facilitate modular portions of the system described herein. For example, portions of the gaming table 800 may be configured to allow for a human dealer to manually deal and operate a game using cards from the card randomization system. Alternatively, or additionally, the gaming table 800 may be configured to allow for an automated system to present and operate the game using the cards from the card randomization system. Sign 812 may advertise elements of the game.

For example, sign 812 may advertise a name of the game or possible outcomes or wagers that may be placed on the game. The gaming table may comprise a plurality of player stations 813, at which individual players may sit or stand to participate in the game. Players may interact with the game via an interface of the player station 813, and players place one or more wagers via a wagering station 822. The tabletop 802 may comprise information about the game, for example wagering options and payouts for particular wagers. A dealer may manually draw cards from an output stacker or card shoe (not shown), and the dealer may present the cards manually on the tabletop 802.

In one embodiment, the cards output by the card randomization system may be output to a presenter 804, and the presenter may facilitate gameplay in an automated manner. For example, a game may comprise one or more players playing against a dealer, and the dealer may have a hand of three cards. The card randomization system may output three cards to the presenter at positions 806, 808, and 810, which may represent the dealers hand. The gameplay may occur based on wagers made by players and the dealer's hand, and the dealers hand may be discarded upon completion of a game. The discarded cards may return to an input of the card randomization system to be reset in the drum, as described in, for example, FIGS. 3 and 7. In one embodiment, the gameplay may proceed with only one card in the presenter visible at a particular time. One or more cards may be output from the card randomization system to position 806 of the presenter in a face-down orientation to prevent players from viewing the card type of the one or more cards. At a determined time, a card may be moved to position 808 of the presenter and be rotated to reveal its face. The card at position 808 may be an active card in the game. The active card may be turned face-down and moved to a third position of the presenter 810, and the third position may be an inactive position of the presenter. The cards in the third position 810 may be sent to an input pathway of the card randomization system to return the cards to the drum described herein.

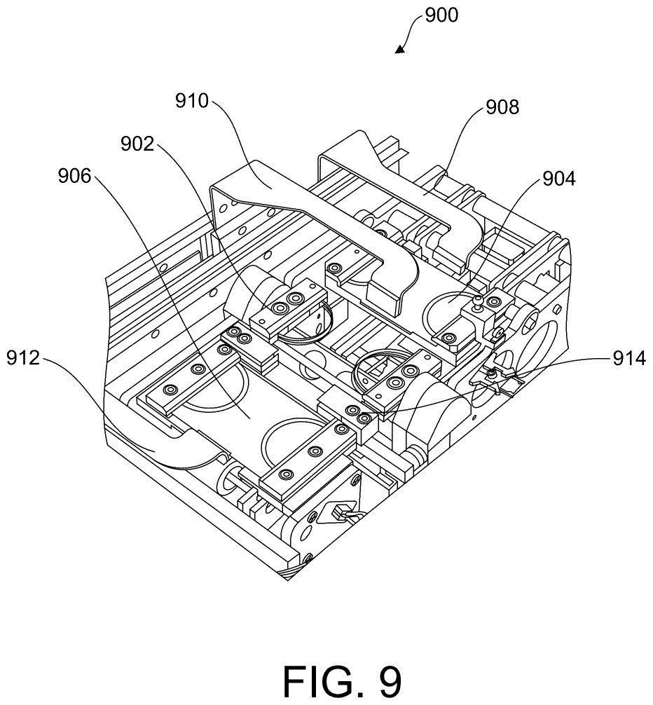

FIG. 9 shows a partial perspective view of a presenter 900. For example, the presenter 900 may be similar to the presenter 804 described in FIG. 8. The presenter comprises a plurality of arms used to propel cards through the presenter 900 from a first position, to a second position, to a third position, and back into an input pathway of the card randomization system. For example, card 906 is shown at a first position of the presenter 900. The system may determine to move the card 906 to a middle, or active, position of the presenter 900. Arm 912 may push the card 906 horizontally out of a first position, through a guide 914, and into the second, or active, position. The active position may comprise a rotator 902, which is activatable to rotate a card from one side to a different side. For example, cards may enter the first position of the presenter face-down, and the face-down cards may be moved to the second position of the presenter. The rotator 902 may rotate the card to a face-up position to reveal an identity of the card. The card may be moved from the second position to a third position of the presenter 904 via an arm 910. The card may be moved from the second position to the third position in a face-up orientation, or the card may be rotated to a face-down orientation and pushed to the third position 904. The card may be moved from the third position 904 in the presenter to an input mechanism of the card randomization system by an arm 908. In embodiments, cards may be shown in more than one position of the presenter in a face-up orientation. In embodiments, each one of the three positions may comprise rotators to optionally rotate cards. In embodiments, the presenter comprises one, two, or more than three positions for presenting cards.

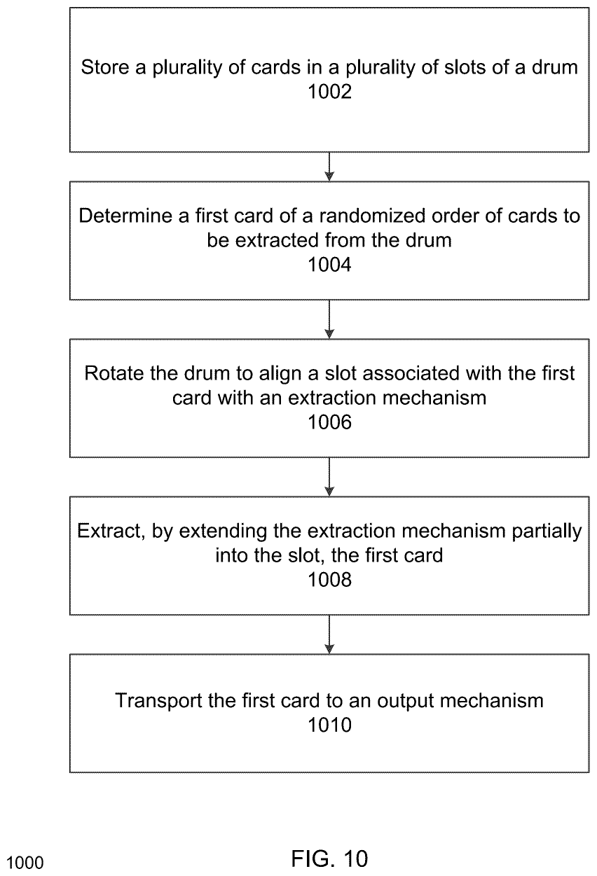

FIG. 10 provides a flowchart of a card randomization system, in accordance with aspects of the present disclosure. The system may be carried out by, for example, the card randomization device described in FIG. 3. The operations may be carried out by a computing device. The computing device may be integrated into the card randomization system. The computing device may be separate from the card randomization system. For example, the computing device may be a server device configured to communicate with components of the card randomization system. The computing device may execute instructions that cause the actions described in FIG. 10.

At block 1002, a card randomization system may be operated, wherein the system comprises a drum with a plurality of slots configured to store a plurality of cards. The drum may be rotated to present any one of the plurality of slots for interaction with input and output mechanisms to insert and extract cards into and out of the slots. The slots may each store one type of card, and there may be a plurality of cards stored in a particular slot. The drum may comprise 52 or more slots, and the slots may store the 52 types of cards in a standard playing card deck. Additional slots may store other types of cards, for example, wild, bonus, joker, or cut cards, or damaged, altered, error, or unrecognizable cards.

At block 1004, a randomization process may determine a randomized order of cards to be presented at a play area to facilitate gameplay of a game. The system may determine an order of cards to extract from the drum to match the randomized order of cards determined by the randomization process.

At block 1006, the system may determine a slot associated with a first card of the randomized order of cards, and the drum may be rotated to align a slot associated with the first card with an extraction mechanism of the card randomization system. The drum may be rotated by one or more motors to align the slot with the extraction mechanism within an acceptable precision.

At block 1008, an inside of the slot may be revealed by actuating a locking arm to move the locking arm away from a default, locked position over an opening of the slot. The extraction mechanism may extend partially into the slot holding the first card, and a belt of the extraction mechanism may come into contact with the first card. For example, the extraction mechanism may extend the belt partially into the slot, and the drum may be slightly rotated to cause the card to come into contact with the belt. The belt may be driven in a manner that lifts the card up and out of the slot.

The extraction mechanism may transport the card to an output mechanism of the system. The output mechanism may comprise a stacker, and the first card may be placed into a first position of the stacker. The locking arm may be returned to a locked position to cover the opening of the slot to prevent additional cards from exiting the slot unintentionally. The drum may be rotated to align a second slot associated with a second card in the randomized card order with the extraction mechanism. The extraction mechanism may extract the second card and move the second card into a second position of the stacker. In this way, the randomized order of cards may be moved into the stacker in the randomized order, and the cards may be presented at the play area to facilitate operation of the game.

The techniques described above can be implemented on a computing device associated with a modular card game system, a plurality of computing devices associated with a plurality of games, a controller in communication with the game(s) (e.g., a controller configured to synchronize the game(s)), or a plurality of controllers in communication with the game(s), such as a GANLOT AMDY-7005, which is designed for gaming applications. The controller module may also provide outputs for the game's lighting, operations, and automated functions.

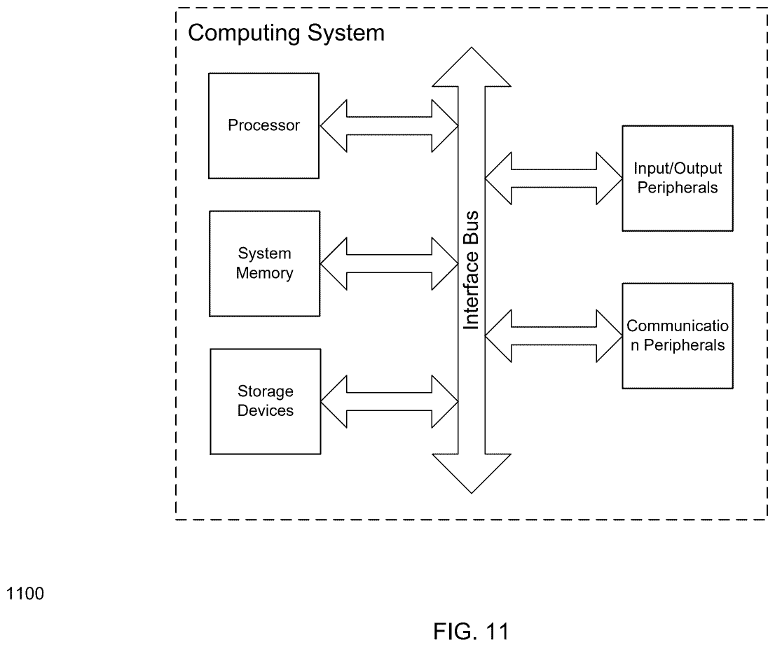

Additionally, the techniques may be distributed between the computing device(s) and the controller(s). FIG. 11 illustrates an exemplary block diagram of a computing system or game server, for games and player stations, which includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the roulette wheel velocity adjustments and result detection optimization, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a Wi-Fi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile, or non-volatile storage.

In an embodiment, a method for operation of a modular card game randomization system comprises storing a plurality of cards in a drum associated with a card randomization system, wherein the drum comprises a plurality of slots configured to store cards, and wherein each slot of the plurality of slots holds one type of card of the plurality of cards. A randomization process may determine a first card to be extracted from the drum. The drum may be rotated to align a first slot associated with the first card with an extraction mechanism, wherein the first slot comprises a first locking arm configured to restrain the first card in the first slot, and wherein the extraction mechanism comprises a first belt on a first side of the first card and at least one of a second belt or a plurality of rollers on a second side of the first card. The first locking arm may be unlocked via a locking arm actuator, and the extraction mechanism may be extended partially into the first slot to extract the first card from the first slot. An identity of the first card may be determined by an image of the first card taken by a camera. The first card may be transported, based on determining that an assigned identity of the first card matches the determined identity of the first card, via the first belt, to an output mechanism of the card randomization system.

In the embodiment, the method comprises receiving, from an input mechanism of the card randomization system, a second card to be inserted into the drum. The second card may be transported, via at least one input belt or a plurality of input rollers, the second card to an input identification mechanism. The identity of the second card may be determined by the input identification mechanism, and the second card may be transported, via the at least one input belt or the plurality of input rollers, to a card return position. The drum may be rotated to align a second slot associated with the determined identity of the second card with the card return position, and a second locking arm configured to restrain one or more cards in the second slot may be unlocked via a different locking arm actuator. The second card may be inserted into the second slot via the input belt or the plurality of input rollers, and the second locking arm may be locked over the second slot.

In the embodiment, wherein the plurality of cards comprises a plurality of decks of playing cards, and wherein each slot is configured to hold a plurality of cards, further comprising causing the first belt to move at a different speed than the at least one of the second belt or the plurality of rollers, causing separating, based on the different speed of the first belt and the at least one of the second belt or the plurality of rollers, two cards extracted from the first slot, and returning a second one of the two cards to the first slot.

In the embodiment, wherein the card randomization system further comprises one or more of a stacker, a card shoe, and a presenter. The stacker comprises an output component to accept, from the output mechanism, an ordered group of cards of the plurality of cards, wherein the output component outputs the ordered group of cards to a play area in the ordered group, and an input component to accept, from the play area, one or more cards used in a game, wherein the input component is configured to return the one or more cards used in the game to the input mechanism. The presenter comprises a viewing area on the play area, wherein the ordered group of cards are configured to be passed through the viewing area to be used in the game without dealing the ordered group of cards to players of the game.

In the embodiment, further comprising a third locking arm actuator located at a position configured to actuate a locking arm of a slot oriented substantially vertically downward, further comprising unlocking, via the third locking arm actuator, a locking arm associated with a third slot, and causing, based on the unlocking and via gravity, a third card located within the third slot to fall out of the third slot.

In the embodiment, wherein the drum comprises at least 52 slots, wherein each slot of the at least 52 slots may be temporarily associated with a particular card type of a deck of playing cards.

In the embodiment, wherein the drum comprises more than 52 slots, and wherein one or more slots are associated with at least one of a bonus card type, a joker card type, a wild card type, a cut card, an unrecognized card type, an altered card type, or error card type.

In the embodiment, wherein each slot of the plurality of slots is randomly associated with one card type, further comprising emptying each one of the plurality of slots, and randomly assigning new card type associations to each one of the plurality of slots.

In the embodiment, wherein each card output via the output mechanism for a game is configured to be returned to each card's associated card slot prior to outputting another set of cards for another game.

In the embodiment, wherein confirming the image of the first card by the camera comprises one or more of: a) a card rotation system configured to rotate a front of a card into a field of view of the camera; b) a camera alignment system configured to move the camera to align the field of view of the camera with the front of the card with the field of view of the camera; or c) a dual camera system comprising a first camera pointed in a first direction associated with one side of the card, and a second camera pointed in a second direction associated with an opposite side of the card.

In an embodiment, a system for operation of a modular card game randomization system comprises a card randomization process configured to determine a randomized order of one or more cards of a plurality of cards. The system further comprises a drum comprising a plurality of slots, the drum configured to store the plurality of cards, wherein each slot of the plurality of slots holds one type of card of the plurality of cards, rotate the drum to align a first slot associated with a first card of the one or more cards with an extraction mechanism of an output system, wherein the first slot comprises a first locking arm configured to restrain the first card in the first slot, and wherein the extraction mechanism comprises a first belt on a first side of the first card and at least one of a second belt or a plurality of rollers on a second side of the first card, and unlock, via a locking arm actuator, the first locking arm. The output system is configured to extend, at least partially into the first slot, the extraction mechanism, extract, via the extended extraction mechanism, the first card from the first slot, determine, based on an image of the first card taken by a camera, an identity of the first card, and transport, based on determining that an assigned identity of the first card matches the determined identity of the first card, and via the first belt, the first card to an output mechanism of the card randomization system.

In the embodiment, the system further comprises an input system configured to receive, from an input mechanism of the card randomization system, a second card to be inserted into the drum, transport, via at least one of an input belt or a plurality of input rollers, the second card to an input identification mechanism, determine, by the input identification mechanism, an identity of the second card, and transport, via the at least one of the input belt or the plurality of input rollers, the second card to a card return position. The drum is further configured to rotate to align a second slot associated with the determined identity of the second card with the card return position, unlock, via a different locking arm actuator, a second locking arm configured to restrain one or more cards in the second slot, accept insertion, via the at least one of the input belt or the plurality of input rollers and into the second slot, the second card, and lock the second locking arm to restrain the second card in the second slot.

In the embodiment, wherein the plurality of cards comprises a plurality of decks of playing cards, and wherein each slot is configured to hold a plurality of cards, further comprising causing the first belt to move at a different speed than the at least one of the second belt or the plurality of rollers, causing separating, based on the different speed of the first belt and the at least one of the second belt or the plurality of rollers, two cards extracted from the first slot, and returning a second one of the two cards to the first slot.

In the embodiment, wherein the card randomization system further comprises one or more of a stacker, a card shoe, and a presenter. The stacker comprises an output component to accept, from the output mechanism, an ordered group of cards of the plurality of cards, wherein the output component outputs the ordered group of cards to a play area in the ordered group, and an input component to accept, from the play area, one or more cards used in a game, wherein the input component is configured to return the one or more cards used in the game to the input mechanism. The presenter comprises a viewing area on the play area, wherein the ordered group of cards are configured to be passed through the viewing area to be used in the game without dealing the ordered group of cards to players of the game.

In the embodiment, further comprising a third locking arm actuator located at a position configured to actuate a locking arm of a slot oriented substantially vertically downward, further comprising unlocking, via the third locking arm actuator, a locking arm associated with a third slot, and causing, based on the unlocking and via gravity, a third card located within the third slot to fall out of the third slot.

In the embodiment, wherein the drum comprises at least 52 slots, wherein each slot of the at least 52 slots may be temporarily associated with a particular card type of a deck of playing cards.

In the embodiment, wherein the drum comprises more than 52 slots, and wherein one or more slots are associated with at least one of a bonus card type, a joker card type, a wild card type, a cut card, an unrecognized card type, an altered card type, or error card type.

In the embodiment, wherein each slot of the plurality of slots is randomly associated with one card type, further comprising emptying each one of the plurality of slots, and randomly assigning new card type associations to each one of the plurality of slots.

In the embodiment, wherein each card output via the output mechanism for a game is configured to be returned to each card's associated card slot prior to outputting another set of cards for another game.

In the embodiment, wherein confirming the image of the first card by the camera comprises one or more of: a) a card rotation system configured to rotate a front of a card into a field of view of the camera; b) a camera alignment system configured to move the camera to align the field of view of the camera with the front of the card with the field of view of the camera; or c) a dual camera system comprising a first camera pointed in a first direction associated with one side of the card, and a second camera pointed in a second direction associated with an opposite side of the card.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed is:

1. A system, comprising:
a card shoe;
an extractor;
a first transport apparatus;
a second transport apparatus;
an input stacker;
an insertion apparatus; and
a card storage device for storing and transporting a plurality of cards, the card storage device comprising:
a rotatable drum, further comprising:
a plurality of lockable slots located radially around a center of the rotatable drum, wherein each slot is configured to store one or more cards of a same card type of the plurality of cards;
one or more arms that, upon actuation, cause unlocking of a slot among the plurality of lockable slots;
wherein the extractor is configured to extract a card from the slot;
wherein the first transport apparatus is coupled to the extractor to:
receive the card from the slot; and
transport the card to a card shoe;
wherein the second transport apparatus is coupled to the input stacker and to the insertion apparatus;
wherein the insertion apparatus receives a used card from an input stacker via the second transport apparatus and inserts the used card into a slot associated with the card type of the used card;
wherein the card shoe is configured to receive the card from the card storage device via the first transport apparatus, wherein the card shoe facilitates use of the card in a card game; and
wherein the input stacker is coupled to the second transport apparatus and configured to:
receive a used card among the plurality of cards, wherein the used card was used in the card game; and
send the used card to the second transport apparatus.

2. The system of claim 1, wherein the card storage device, the card shoe, and the input stacker are each coupled to a card table for playing the card game, and wherein the card table comprises a surface for presentation of one or more cards among the plurality of card for use during the card games and a skirt blocking a view of an underside of the card table.

3. The system of claim 2, wherein the card storage device is hidden below the surface of the card table and hidden from view by the skirt.

4. The system of claim 2, wherein the input stacker further comprises:
a first orientation hidden below the surface of the card table; and
a second orientation raised above the surface of the card table and configured to receive the used card from a dealer of the card game.

5. The system of claim 1, wherein the card type may comprise one or more of an unrecognizable card type, a cut card type, a joker card type, a damaged card type, a marked card type, an ace of spades card type, a two of spades card type, a three of spades card type, a four of spades card type, a five of spades card type, a six of spades card type, a seven of spades card type, an eight of spades card type, a nine of spades card type, a ten of spades card type, a jack of spades card type, a queen of spades card type, a king of spades card type, an ace of hearts card type, a two of hearts card type, a three of hearts card type, a four of hearts card type, a five of hearts card type, a six of hearts card type, a seven of hearts card type, an eight of hearts card type, a nine of hearts card type, a ten of hearts card type, a jack of hearts card type, a queen of hearts card type, a king of hearts card type, an ace of clubs card type, a two of clubs card type, a three of clubs card type, a four of clubs card type, a five of clubs card type, a six of clubs card type, a seven of clubs card type, an eight of clubs card type, a nine of clubs card type, a ten of clubs card type, a jack of clubs card type, a queen of clubs card type, a king of clubs card type, an ace of diamonds card type, a two of diamonds card type, a three of diamonds card type, a four of diamonds card type, a five of diamonds card type, a six of diamonds card type, a seven of diamonds card type, an eight of diamonds card type, a nine of diamonds card type, a ten of diamonds card type, a jack of diamonds card type, a queen of diamonds card type, or a king of diamonds card type.

6. The system of claim 1, wherein the plurality of lockable slots may be updated to change the card type associated with each slot.

7. The system of claim 1, wherein the second transport apparatus further comprises a card flipping mechanism to:
determine an orientation of each card on the second transport apparatus; and
based on determining a particular card is in an incorrect orientation, flipping the card to a correct orientation.

8. A method, comprising:
determining a randomized order of a subset of cards of a plurality of cards for use in an instance of a card game, wherein the game comprises, in part, displaying the subset of cards in the randomized order;
determining a storage location associated with each card of the subset of cards, wherein each card of the plurality of cards is stored in one of a plurality of slots of a storage device, and wherein each slot of the plurality of slots is configured to store one or more cards of a single card type;
transporting each card, of the subset of cards and in the randomized order, from the storage location to a card shoe, wherein the card shoe is configured to hold the subset of cards in the randomized order;
outputting, from the card shoe to a dealer, the subset of cards in the randomized order, wherein the card shoe is configured to output one card to the dealer per interaction, and wherein the output cards are configured to facilitate execution of the instance of the card game;
receiving, at an input stacker and from the dealer, each used card of the subset of cards; and
transporting each used card of the subset of cards to the storage device, wherein each used card is returned to its corresponding storage location.

9. The method of claim 8, wherein the storage device, the card shoe, and the input stacker are each coupled to a card table for playing the card game, and wherein the card table comprises a surface for presentation of the cards and a skirt blocking a view of an underside of the card table.

10. The method of claim 9, wherein the storage device is hidden below the surface of the card table and hidden from view by the skirt.

11. The method of claim 9, wherein the input stacker further comprises:
a first orientation hidden below the surface of the card table; and
a second orientation raised above the surface of the card table and configured to receive each used card from the dealer.

12. The method of claim 8, wherein the card type may comprise one or more of an unrecognizable card type, a cut card type, a joker card type, a damaged card type, a marked card type, an ace of spades card type, a two of spades card type, a three of spades card type, a four of spades card type, a five of spades card type, a six of spades card type, a seven of spades card type, an eight of spades card type, a nine of spades card type, a ten of spades card type, a jack of spades card type, a queen of spades card type, a king of spades card type, an ace of hearts card type, a two of hearts card type, a three of hearts card type, a four of hearts card type, a five of hearts card type, a six of hearts card type, a seven of hearts card type, an eight of hearts card type, a nine of hearts card type, a ten of hearts card type, a jack of hearts card type, a queen of hearts card type, a king of hearts card type, an ace of clubs card type, a two of clubs card type, a three of clubs card type, a four of clubs card type, a five of clubs card type, a six of clubs card type, a seven of clubs card type, an eight of clubs card type, a nine of clubs card type, a ten of clubs card type, a jack of clubs card type, a queen of clubs card type, a king of clubs card type, an ace of diamonds card type, a two of diamonds card type, a three of diamonds card type, a four of diamonds card type, a five of diamonds card type, a six of diamonds card type, a seven of diamonds card type, an eight of diamonds card type, a nine of diamonds card type, a ten of diamonds card type, a jack of diamonds card type, a queen of diamonds card type, or a king of diamonds card type.

13. The method of claim 8, wherein the plurality of slots may be updated to change the card type associated with each one of the plurality of slots.

14. The method of claim 8, wherein transporting each used card to the storage device further comprises:
determining an orientation of each used card received at the input stacker; and
based on determining a particular used card is in an incorrect orientation, flipping the particular used card to a correct orientation.

15. A method, comprising:
transporting, based on a determination to execute a manual instance of a card game, a first randomized order of a first subset of cards of a plurality of cards stored at a card storage device, from the card storage device to a card shoe, wherein the card shoe is configured to allow dispensation of the first subset of cards for use in the manual instance of the card game;
receiving, at an input stacker, dispensed cards of the first subset of cards; and
transporting the dispensed cards of the first subset of cards from the input stacker to the card storage device, wherein each dispensed card is returned to a slot associated with the card type of each dispensed card;
actuating, based on a determination to execute an automatic instance of the card game, a mechanism to transition from a manual presentation system to an automated presentation system;
transporting a second randomized order of a second subset of cards of the plurality of cards stored at the card storage device from the card storage device to an output stacker, wherein the output stacker is configured to hold the second subset of cards;
presenting, via a first pathway and to a presenter, the second subset of cards, wherein the presenter comprises a viewing area comprising one or more card presentation positions, and wherein executing the automatic instance of the game comprises passing the second subset of cards through the viewing area in the second randomized order; and
transporting each presented card of the second subset of cards from the presenter to the card storage device, wherein each presented card is returned to a slot associated with the card type of each presented card.

16. The method of claim 15, the input stacker further comprising:
a first orientation hidden from a view of participants in instances of the card game; and
a second orientation raised into view of the participants of instances of the card game, wherein the stacker receives the dispensed cards and the presented cards in the second orientation.

17. The method of claim 15, wherein the presenter comprises a transparent cover to facilitate viewing each one of the subset of cards at the presenter and prevent tampering with the subset of cards at the presenter.

18. The method of claim 17, further comprising covering, based on the determination to execute the manual instance of the card game, the presenter with an opaque cover.

19. The method of claim 15, further comprising:
capturing, by at least one camera, at least one image of each dispensed card of the first subset of cards received at the output stacker; and
determining an associated card type for each one of the dispensed cards of the first subset of cards.

20. The method of claim 15, further comprising executing a plurality of manual instances of the game from the first subset of cards, wherein the dispensed cards of the first subset of cards received by the stacker are transported to the card storage device based on a determination that each manual instance of the plurality of manual instances of the game is completed.
